(19) United States
(12) Patent Application Publication
(10) Pub. No.: US 2004/0244035 A1
(43) Pub. Date: Dec. 2, 2004

(54) Commercial replacement systems and methods using synchronized and buffered TV program and commercial replacement streams

(75) Inventors: Winston Hugh Wright, Rancho Palos Verdes, CA (US); Daniel A. Radke, Manhattan Beach, CA (US)

Correspondence Address: Mitchell S. Bigel, Myers Bigel Sibley & Sajovec, P.A., P. O. Box 37428, Raleigh, NC, 27627, US

(73) Assignee: Microspace Communications Corporation, Raleigh, NC

(21) Appl. No.: 10/848,419

(22) Filed: May 18, 2004

Related U.S. Application Data
(60) Provisional application No. 60/473,857, filed on May 28, 2003.

(51) Int. Cl. H04N 7/10; H04N 7/025; H04N 5/45

(52) U.S. Cl. 725/32; 348/565; 725/35; 725/34

(57) ABSTRACT

A television program stream that includes television programs and at least one original commercial, and a commercial replacement stream that includes at least one replacement commercial, are received simultaneously such that a respective replacement commercial is approximately synchronized in time with a respective original commercial. The television program stream and/or the commercial replacement stream is buffered to substantially synchronize a respective replacement commercial with a respective original commercial. Selective switching is performed between the television program stream and the commercial replacement stream, to provide a television program output that includes the television programs and the at least one replacement commercial instead of the at least one original commercial. Accordingly, commercial replacement may be provided in set top boxes without the need for mass storage devices to store the replacement commercials. Regional and/or national commercials may thereby be replaced by local commercials in TV markets and for multiple regional and/or national channels.

### CROSS-REFERENCE TO PROVISIONAL APPLICATION

This application claims the benefit of and priority from provisional Application No. 60/473,857, filed May 28, 2003, entitled Commercial Replacement and Insertion in DBS Systems, assigned to the assignee of the present application, the disclosure of which is hereby incorporated herein by reference in its entirety as if set forth fully herein.

### FIELD OF THE INVENTION

This invention relates to television broadcast transmitting and receiving methods and systems, and more particularly to commercial replacement systems and methods for television broadcasts.

### BACKGROUND OF THE INVENTION

Direct Broadcast Satellite (DBS) television (TV), cable television, terrestrial, and Internet television broadcast (transmission) and receiving systems, methods and transmission formats are widely used. As is well known to those having skill in the art, these systems and methods generally include a broadcast system, such as DBS ground and space segments, a cable TV head end, a terrestrial transmitter and/or an Internet TV server, and a receiver that is often referred to as a “set top box” and that is configured to receive television signals and provide these signals to a television receiver. The term “set top box” is used herein generically to refer to a user control center for receiving DBS, cable, terrestrial, and/or Internet television broadcasts, and providing a television program output to a television receiver. The set top box functionality may be integrated at least partially in a television and/or other device, such as a digital video recorder. Moreover, as used herein, a television receiver is used generically to include any audio and/or video playing system, including a video monitor, computer display, audio system and/or home theater system.

As is well known to those having skill in the art, it may be desirable for a television program broadcaster and/or television program viewer to preempt commercials in favor of other commercials. For example, a cable or satellite network may broadcast television programs with commercials that can be preempted by a local cable company or a network affiliate in favor of local advertisements. Alternatively, a user may desire original commercials to be replaced by replacement commercials that are of greater interest to the user. The activity of replacing original commercials with replacement commercials is generally referred to as “commercial replacement”.

Commercial replacement systems and methods are well known to those having skill in the art. For example, U.S. Patent Application Publication No. US 2003/0033157 A1 to Dempski et al., provides an “Enhanced Custom Content Television”. As noted in the Dempski et al. Abstract, Dempski et al. includes a system and method for combining television broadcast programming content with customized or personalized information and educational or entertainment content. The system includes a set-top box capable of receiving data transmissions and locally rendering video animation for display with, instead of, and/or synchronized with television broadcast programs in a way that the television viewer sees a coherent seamless merging of the television program content and supplemental content sources in an indistinguishable format. Preferably, the viewer may interact in real-time with the enhanced television programming to provide a higher level of engagement and customization potential.

Moreover, U.S. Patent Application Publication No. US 2002/0157093 A1 to Akiyama et al. provides a “TV Program Broadcasting Method, TV Receiver and Medium”. As noted in the Akiyama et al. Abstract, a sharp-image commercial suited to each viewer is provided. TV programs are previously accumulated in a hard disk. A TV commercial suited to the viewer is selected from among plural categories of TV commercials transmitted from respective enterprises, corresponding to pre-registered information on the viewer, and is accumulated in the hard disk memory. The TV commercial accumulated as a TV commercial televised in an interval of a TV program is inserted to edit a program. The viewer is able to watch the TV commercial suited to the viewer himself or herself together with the TV program by selecting the favorite program by operating a remote controller.

U.S. Patent Application Publication No. US 2003/0023972 A1 to Gutta et al. provides a “Method for Charging Advertisers Based on Adaptive Commercial Switching Between TV Channels”. As noted in the Gutta et al. Abstract, disclosed is a method and system for switching a commercial for a user. Accordingly, Gutta et al. obtains a user's profile or monitors a user's viewing history of various commercials to determine the type of commercials that are not watched or not liked by the user. Thereafter, commercials between television programs are detected during a commercial break and compared with the user's profile or the user's past viewing information to determine whether the detected commercial is liked by the user. For an unwanted commercial, Gutta et al.'s system retrieves one of the commercials liked by the user that is shown on different channels, then replaces the unwanted commercial with the commercial that is of interest to the user.

U.S. Patent Application Publication No. 2003/0005052 A1 to Feuer et al. provides a “Networked Broadcasting System With Provision for the Addition of Advertisements or Messages”. As noted in the Feuer et al. Abstract, an Internet based broadcasting system manages the insertion of advertisements and other messages into multiple broadcasts of live sporting events and other types of broadcasts. The insertion of advertisements and other messages is governed by program logs generated by a traffic system, signals extracted from the broadcasts themselves, and signals received from producer systems. The traffic system facilitates the marketing of advertising opportunities for the multiple broadcasts packaged in a variety of ways. The broadcasts are received by tuner systems that are automatically downloaded and installed on user's computers. The tuner systems can download and display demographically selected multimedia advertisements, banner advertisements, and a variety of messages that may be called for by the producer systems, which may be wireless portable computers that can be carried to sports events or other broadcasts by the producers of the broadcasts. Also see U.S. Patent Application Publication Nos. US 2003/0005437 A1 and US 2003/0004793 A1 to Feuer et al.

Finally, U.S. Patent Application Publication No. 2002/0073421 A1 to Levitan et al. provides a “System For Targeted Advertisement, Personal Editing and Parental Control In a Television Network”. As noted in the Levitan et al. Abstract, a system is provided for automatic personal editing of television programs based on viewer's information privately stored in viewer's computerized television receivers. The system, when activated, protects viewers, first of all children, filtering out everything that is unacceptable or useless. The filtering is carried out on three levels: blocking television programs, blocking some parts of the programs and replacing some parts by alternative video fragments. In particular, the system replaces a television commercial meaningless for a viewer by a commercial that may be of certain interest to the viewer. Another application is an improvement in management of controversial matter such as sex and violence. Depending on viewer's preferences the system replaces a certain scene by a commercial or restores such a scene if it has been replaced by a commercial in a program edited for broadcast television. The replacement technique uses basic channels for transmission of primary versions of television programs and auxiliary channels for transmission of alternative video fragments intended for replacement of some parts of the primary versions. A computerized receiver makes a decision on a replacement comparing viewer's information with information on the primary and alternative parts.

### SUMMARY OF THE INVENTION

Television program receiving methods according to some embodiments of the present invention simultaneously receive a television program stream that includes television programs and at least one original commercial, and a commercial replacement stream that includes at least one replacement commercial, such that a respective replacement commercial is approximately synchronized in time with a respective original commercial. The television program stream and/or the commercial replacement stream is buffered to substantially synchronize a respective replacement commercial with a respective original commercial. Selective switching is performed between the television program stream and the commercial replacement stream that are substantially synchronized, to provide a television program output that includes the television programs and the at least one replacement commercial instead of the at least one original commercial.

Moreover, in some embodiments, the television program stream and/or the commercial replacement stream include switch commands that identify parameters for selectively switching between the television program stream and the commercial replacement stream, such that selective switching is performed responsive to the switch commands. In other embodiments, a separate switch command stream that includes switch commands can be received instead of and/or in addition to the switch commands in the television program stream and/or the commercial replacement stream. Again, selective switching is performed responsive to the switch commands. In some embodiments, selective switching uses well known “splicing” technology that is widely used by television broadcasters for program and/or commercial splicing.

Other embodiments of the present invention provide television program transmitting or delivery methods, wherein a direct broadcast satellite television regional program stream that includes regional television programs and at least one original commercial, and a direct broadcast satellite local commercial replacement stream that includes at least one local replacement commercial, are simultaneously transmitted, such that a respective replacement commercial is approximately synchronized in time with a respective original commercial. As used herein, the terms “regional” and “local” are merely used in a relative sense, such that a regional stream spans a larger geographic area than a local stream. Thus, a regional program stream can include a national program stream or a regional program stream, and a local commercial replacement stream can include a regional or local commercial replacement stream for the national or regional program stream, respectively.

In some embodiments, local commercial replacement streams may originate from a plurality of locations distinct from a regional transmitting site. In this way, the original commercial can be replaced by a different local commercial in a plurality of, or every, local market. As was described above, switch commands also may be provided. Moreover, in some embodiments of the present invention, a first and a second direct broadcast satellite television regional program stream may be simultaneously transmitted along with a local commercial replacement stream that includes replacement commercials for both the first and the second television broadcast streams. Again, in some embodiments, local commercial replacement streams can originate from a multiplicity of transmitting locations for the first and second regional program streams.

Still other embodiments of the present invention provide set top boxes. These set top boxes can include a receiver that is configured to simultaneously receive a television program stream that includes television programs and at least one original commercial, and a commercial replacement stream that includes at least one replacement commercial, such that a respective replacement commercial is approximately synchronized in time with a respective original commercial. A synchronization buffer is provided to buffer the television program stream and/or the commercial replacement stream that are approximately synchronized in time, to substantially synchronize a respective replacement commercial with a respective original commercial. These set top boxes can also include a switch that is configured to selectively switch between the television program stream and the commercial replacement stream that are substantially synchronized, to provide a television program output that includes the television programs and the at least one replacement commercial instead of the at least one original commercial. Switch commands also may be provided in the television program stream, in the commercial replacement stream and/or in a switch command stream, and the switch can be controlled by the switch commands. In some embodiments, the switch can comprise a splicer and the set top box can also include an output system that is configured to provide the television program output to a television receiver. The replacement commercial that is received, synchronized and switched in the set top box can depend on the market in which the set box is situated and can be different for each market.

### BRIEF DESCRIPTION OF THE DRAWINGS

FIGS. 1-3 are block diagrams of commercial replacement systems and methods using simultaneous TV program and commercial replacement streams according to various embodiments of the present invention.

FIG. 4 is a flowchart of operations that may be performed according to various embodiments of the present invention.

FIGS. 5 and 6 are block diagrams of other embodiments of the invention.

### DETAILED DESCRIPTION

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. It will be understood that when an element is referred to as being “responsive to” or “controlled by” another element, it can be directly responsive to or controlled by the other element or intervening elements may be present. In contrast, when an element is referred to as being “directly responsive to” or “directly controlled by” another element, there are no intervening elements present.

It will also be understood that although the terms first and second are used herein to describe various elements, these elements should not be limited by these terms. These terms are only used to distinguish one element from another element. Thus, a first element below could be termed a second element, and similarly, a second element may be termed a first element without departing from the teachings of the present invention. As used herein, the term “and/or” includes any and all combinations of one or more of the associated listed items.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

The present invention is described below with reference to block diagrams and/or flowchart illustrations of methods, apparatus (systems) and/or computer program products according to embodiments of the invention. It is understood that each block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

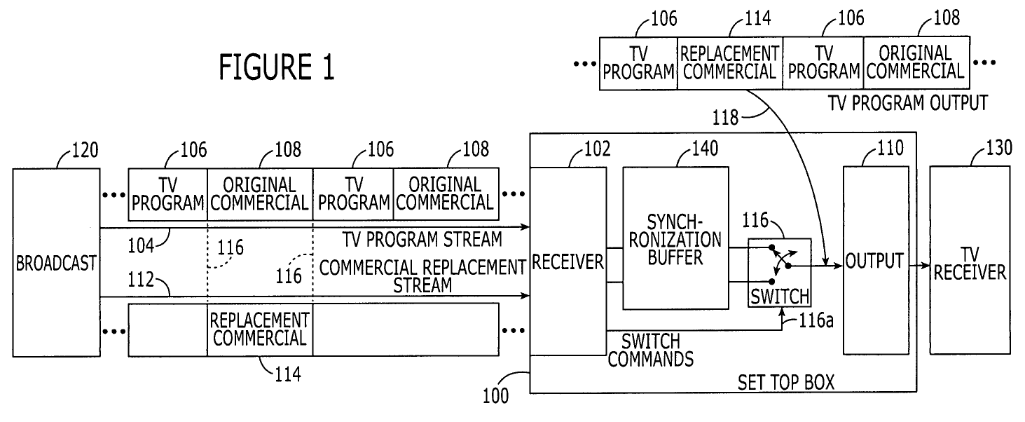

Referring now to FIG. 1, a set top box 100, a broadcast system 120 and a TV receiver 130 are provided. It will be understood by those having skill in the art that although a single set top box 100, broadcast system 120 and TV receiver 130 are illustrated in FIG. 1, larger numbers of any or all of these elements also may be provided. It will further be understood that the broadcast system 120 may be distributed over multiple geographic locations so that the TV program stream 104 and commercial replacement stream 112 of a broadcast system may emanate from disparate locations.

Still referring to FIG. 1, the set top box 100 includes a receiver 102 that is configured to simultaneously receive a television program stream 104 that includes television programs 106 and at least one original commercial 108, and a commercial replacement stream 112 that includes at least one replacement commercial 114. As shown in FIG. 1, a respective replacement commercial 114 is approximately synchronized in time with a respective original commercial 108, as shown by dashed lines 116. As used herein, “approximately synchronized in time” means sufficiently synchronized in time such that a respective replacement commercial 114 can be substituted for a respective original commercial 108, without the need to store the TV program 106 or the replacement commercial 114 in a mass storage device, but rather can be synchronized for a seamless transition (from the perspective of the user) between the replacement commercial 114 and the original commercial 108 using a buffer. In some embodiments, “approximately synchronized in time” means synchronized within about 1 second.

As also shown in FIG. 1, the set top box 100 also includes a synchronization buffer 140 that is configured to buffer the television program stream 104 and/or the commercial replacement stream 112 that are approximately synchronized in time to substantially synchronize a replacement commercial 114 with an original commercial 108. As used herein, “substantially synchronize” means sufficiently synchronized in time such that a respective replacement commercial 114 can be substituted for a respective original commercial 108, to provide for a seamless transition (from the perspective of the user) between the replacement commercial 114 and the original commercial 108. In some embodiments, “substantially synchronized in time” means synchronized within about 25 milliseconds.

Still continuing with the description of FIG. 1, a switch 116 also is provided in the set top box 100, that is configured to selectively switch between the television program stream 104 and the commercial replacement stream 112, to provide a television program output 118 that includes the television programs 106 and the at least one replacement commercial 114 instead of the at least one original commercial 108. The synchronization buffer 140 is responsive to the switch 116. In some embodiments, the switch 116 is embodied by a conventional splicer that is well known to those having skill in the art in broadcasting systems and methods. As also shown in FIG. 1, a set top box according to some embodiments of the present invention may also include an output system 110 that is configured to provide the television program output 118 that includes the television programs. 106 and the at least one replacement commercial 114 instead of the at least one original commercial 108 to a television receiver 130.

Some embodiments of the present invention may arise from a recognition that mass storage devices, such as solid state, magnetic and/or optical mass storage devices may be costly and/or otherwise undesirable to provide in a set top box 100. In some embodiments, by approximately synchronizing an original commercial 108 in the television program stream 104 and a replacement commercial 114 in the commercial replacement stream 112, and providing a synchronization buffer 140, commercial replacement may be provided in a set top box that is free of a mass storage device that is configured to store the television program stream and/or the commercial replacement stream. Mass storage devices may or may not be provided for other purposes, but need not be provided for commercial replacement. Moreover, by not providing mass storage of the television program stream 104 and/or the commercial replacement stream 112 in the set top box 100, enhanced security may be provided, compared with splicing from storage and switch commands solely within the program stream 104, which can reduce or eliminate the ability of the user to skip commercials. Enhanced acceptance by the broadcasting community thereby may be provided.

As also shown in FIG. 1, the switch 116 is responsive to switch commands 116a. The switch commands identify parameters for selectively switching between the television program stream 104 and the commercial replacement stream 112 that are received simultaneously, and may be included within the television program stream 104 and/or the commercial replacement stream 112. Switch commands are widely used in the broadcasting field for various purposes, and need not be described further herein. Accordingly, the switch 116 is configured to selectively switch in response to the switch commands 116a.

Still referring to FIG. 1, the broadcast system 120 is configured to simultaneously transmit the television program stream 104 and the commercial replacement stream 112, such that a respective original commercial 108 and a respective replacement commercial 114 are approximately or substantially synchronized in time, as was described above.

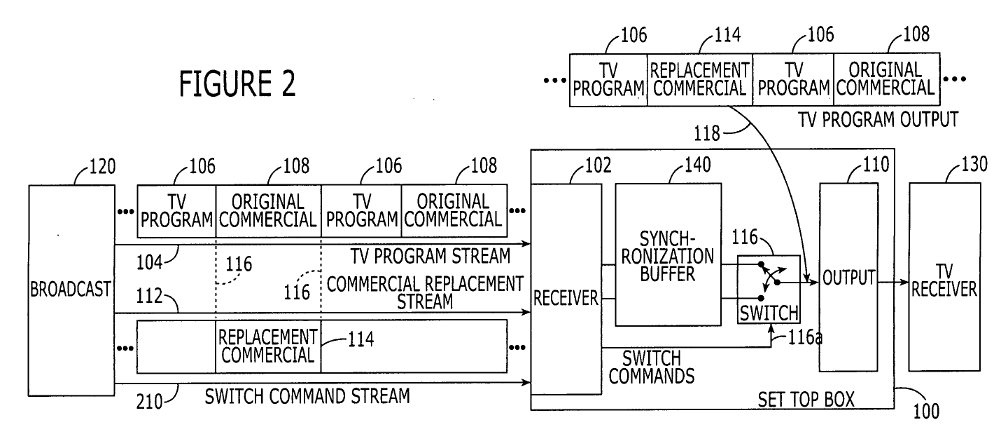

FIG. 2 is a block diagram of other embodiments of the present invention. As shown in FIG. 2, a switch command stream 210 is transmitted by the broadcast system 120 and received by the receiver 102. The switch command stream 210 includes switch commands that identify parameters for selectively switching between the television program stream 104 and the commercial replacement stream 112. The switch 116 uses the switch commands 116a from the switch command stream 210 to selectively switch between the TV program stream 104 and the commercial replacement stream 112. In some embodiments of the present invention, all switch commands 116a may be contained within the switch command stream 210. In other embodiments of the invention, all switch commands may be contained within the TV program stream 104 and/or the commercial replacement stream 112. In still other embodiments of the present invention, the switch commands 116a may be contained in the TV program stream 104, in the commercial replacement stream 112 and in the switch command stream 210.

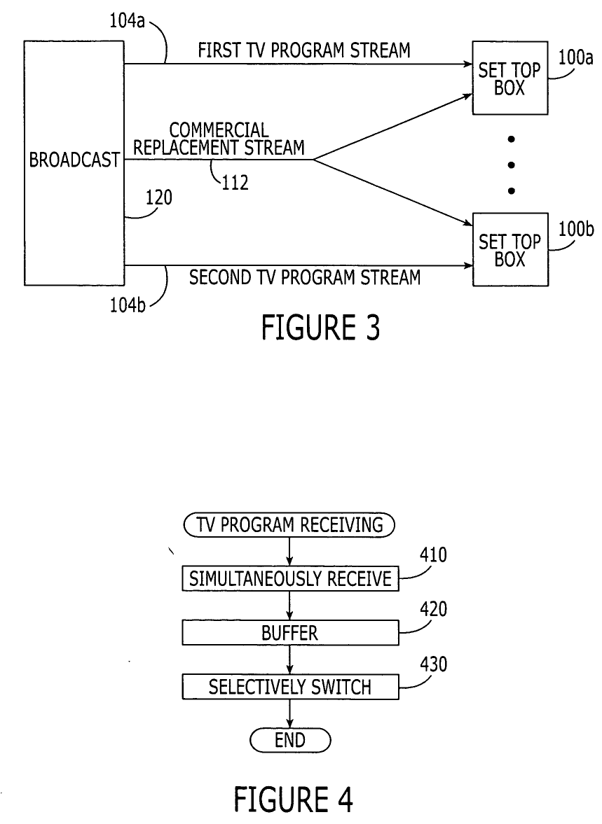

FIG. 3 illustrates other embodiments of the present invention, wherein a commercial replacement stream includes replacement commercials for more than one TV program stream. In particular, embodiments of FIG. 3 may arise from recognition that the commercial replacement stream 112 may-contain much less content than the TV program stream 104. Accordingly, replacement commercials may be provided in a single commercial replacement stream 112 for a plurality of TV program streams 104a, 104b that are provided to a plurality of set top boxes 100a, 100b provided that the times of the replacement commercials 114 do not overlap one another. Accordingly, enhanced use of the bandwidth provided in the commercial replacement stream 112 may be provided. It will also be understood that, although FIG. 3 illustrates first and second TV program streams 104a and 104b and first and second set top boxes 100a and 100b, larger numbers of TV program streams and/or set top boxes may be provided. It will be further understood that, although FIG. 3 illustrates a singular commercial replacement stream 112, larger numbers of replacement streams may be provided.

FIG. 4 illustrates operations that may be performed according to various embodiments of the present invention. These operations may be performed, for example, by a set top box 100 of FIGS. 1-3.

Referring now to FIG. 4, at Block 410, a television program stream that includes television programs and original commercials, and a commercial replacement stream that includes replacement commercials, are simultaneously received as was described above. The television program stream and the commercial replacement stream are approximately synchronized in time, and buffering is performed at Block 420 to substantially synchronize the replacement commercials with the original commercials. Finally, at Block 430, selective switching is performed between the television program stream and the commercial replacement stream, to provide the television program output that includes the television programs and at least one of the replacement commercials instead of at least one of the original commercials. A switch back to the television program stream after the replacement commercial also may be buffered as was described above, to provide substantial synchronization. As was described above, selective switching of Block 430 may be performed in response to switch commands 116a that may be provided in the TV program stream 104, the commercial replacement stream 112 and/or the switch command stream 210.

In some embodiments of the present invention, the television program stream 104 comprises a direct broadcast satellite television regional program stream, and the commercial replacement stream 112 comprises a direct broadcast satellite local commercial replacement stream. Accordingly, in transmitting methods according to some embodiments of the present invention, a direct broadcast satellite television regional program stream that includes regional television programs and at least one original commercial, and a direct broadcast satellite local commercial replacement stream that includes at least one local replacement commercial, are simultaneously transmitted such that a respective replacement commercial is approximately synchronized in time with a respective original commercial. In other embodiments, the direct broadcast satellite television regional program stream and the direct broadcast satellite local commercial replacement stream are substantially synchronized in time. Switch commands may be provided in the television program stream 104, in the commercial replacement stream 112 and/or in a switch command stream 210. Moreover, as used herein, the terms “regional” and “local” are merely used in a relative sense, such that a regional stream spans a larger geographic area than a local stream. Thus, a regional program stream can include a national program stream or a regional program stream, and a local commercial replacement stream can include a regional or local commercial replacement stream for the national or regional program stream, respectively.

Additional discussion of embodiments of FIGS. 1-4 now will be provided. As was described in connection with FIGS. 1-4, in some embodiments of the present invention, selectively switching between the television program stream 104 and the commercial replacement stream 112 that are received simultaneously can employ a “splicing” technique, wherein two or more digitally compressed bit streams are fed to a switch and the switch controls selection of the desired output bitstream. The switch's output signal is composed of a single bitstream that is sourced from any of the available input bitstreams. For example, in some embodiments of the present invention, a TV program stream such as Cable News Network (CNN) provides one input to a switch. When a commercial is aired on the CNN input, the receiver is commanded also to select a replacement stream and the switch is commanded to output an alternative program stream from the switch's input containing an alternative commercial. At the end of the commercial, the switch is commanded to return to the CNN program stream. The input to the switch for commercials is from a live (real time) feed. Since, in some embodiments, the TV program stream and the commercial replacement stream may be digitally compressed signals, real time may refer to the delivery of the replacement commercial material.

In some embodiments of the present invention, the set top box 100 can include two tuners and demultiplexers, to allow simultaneous reception of the TV program stream 104 and the commercial replacement stream 112. The channel containing the replacement material is timed so that the commercial for insertion arrives at the set top box 100 at approximately the same time as the regular program channel is airing the commercial to be replaced. The commands for splicing may originate from specific signals embedded in the program stream and/or a separate data stream with splicing information.

In some embodiments, the broadcast system 120 can contain N dedicated channels 112, also designated as “X channels”, for broadcasting commercials in real time (either from uplink video servers or other playout devices). The broadcasting system 120 also may include a scheduling function that is aware of the approximate times at which commercials may be replaced in each of the respective channels. The broadcasting system 120 can initiate playout on one of the X channels of a replacement commercial, based on absolute time and/or trigger information provided in the program stream incoming to the uplink. The broadcast system 120 may simultaneously generate a Y data channel 210, that the set top box 100 can always monitor, which includes the switch commands for the set top box. For example, the switch commands can indicate to the set top box 100 which X channel to select. The broadcast system can service up to N such commercial replacements from each uplink at any time, which can accommodate more than N regular program channels if they do not all have commercial breaks at the same time.

The Y channel can contain cue messages (advance of playout) and triggers to control the splicer. The cue messages and triggers can have tags to identify an appropriate X channel replacement stream 112 containing the replacement commercial 114. In embodiments in which signaling within the main program stream 104 is employed, the set top box 100 can manage the switch commands based on rules from the commercial's metadata and/or the program signaling. The program signaling may employ conventional SCTE and/or MPEG standards for splice signaling applied by the program provider and passed through the broadcast system 120 to the set top box 100. Alternatively, the broadcast system 120 may apply its own signaling. In another alternative, the broadcast system 120 may convert, translate or re-encrypt existing signaling applied by the program provider, and pass on the modified signaling to the set top box 100.

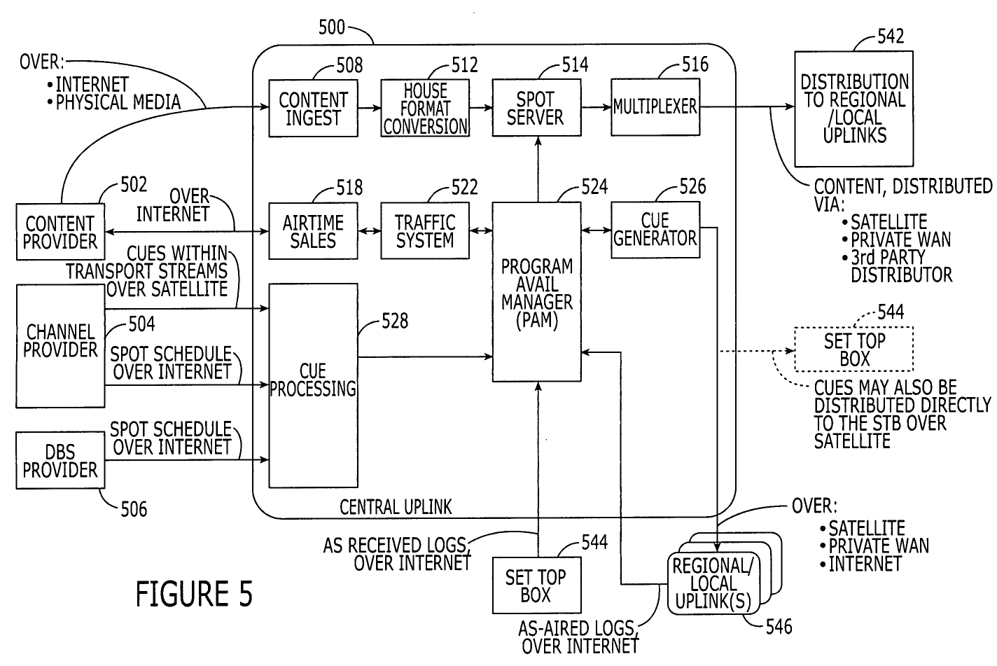

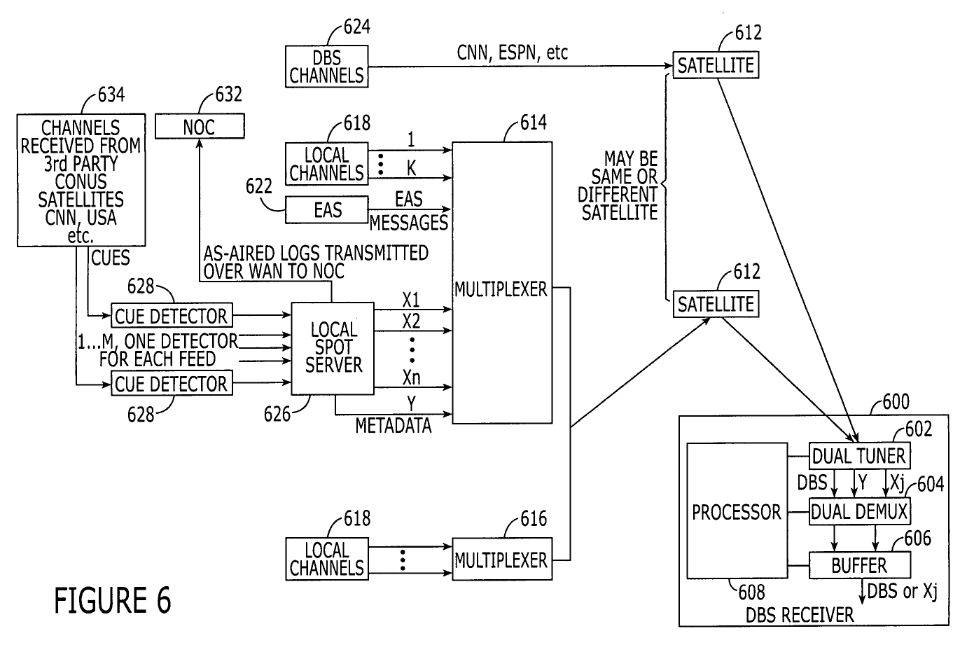

Other embodiments of commercial replacement systems and methods will now be described within the context of DBS systems, and with reference to FIGS. 5 and 6. Referring to FIG. 6, one or more direct broadcast satellites 612 deliver a number of TV channels to a set top box 600. An uplink, which can be part of the DBS network, and/or can be a third party uplink providing channels as a service to the DBS network, also can deliver channels to the set top box 600. These can be local TV channels 618, for example, as well as channels (X₁, X₂, . . . , Xₙ) containing commercial messages that will replace commercials in the DBS channels. Note that the satellites 612 in FIG. 6 can in fact be the same satellite, or can be satellites in different orbital locations.

The set top box 600 is capable of receiving from both satellites 612. The set top box 600 is tuned to one of the DBS channels and can always be tuned to one of the channels (X₁, X₂, . . . , Xₙ) using a dual tuner 602 and demultiplexer 604 (channel Xj is selected in FIG. 6). A data channel Y is multiplexed with (X₁, X₂, . . . , Xₙ). The output of the set top box buffer 606 is normally the DBS channel selected by the viewer, except when a commercial in the DBS channel is replaced with one in one of the channels (X₁, X₂, . . . , Xₙ). The buffer 606 can be used to adjust the timing of the signals so that the switch between DBS and (X₁, X₂, . . . , Xₙ) channels is seamless, or nearly so. The set top box 600 can apply freezing during splices that are not seamless.

The processor 608 in the set top box 600 can use the Y data channel to select one of the channels (X₁, X₂, . . . or Xₙ). The Y data can include a schedule of near-term splices in cue messages as well as splice requests to switch channel streams at specific frame boundaries. A start of insertion splice request for the currently tuned DBS channel can effect the switch to the appropriate (X₁, X₂, . . . , Xₙ) carrying the commercial that will replace one in the DBS channel. An end of insertion splice request can instruct the set top box to return to the previous DBS channel when one commercial or a contiguous block of commercials has been replaced.

A spot server 626 in the uplink can allocate a spot to the first available (non-busy) spot channel (X₁, X₂, . . . , Xₙ). If there is only one channel available at any instant it can be assigned to the largest market competing for it or some other priority scheme can be used. If a spot is not inserted because all the spot channels are busy, the spot server can record the need for a make-good.

The server controller can create the data channel Y containing the metadata describing the spot. These metadata can contain one or more of the following among other data:

spot ID(s)

channel number (X₁, X₂, . . . Xₙ) assigned to the spot

DBS channel (CNN, ESPN, etc) into which the spot will be inserted

market or markets for which the spot is intended

spot or break duration

near-term schedule of insertions for the DBS channels

start of insertion splice requests

end of insertion splice requests.

Material is delivered to a spot server 626 at a local or regional uplink from the NOC 632. Commercial material delivered to the spot server can be in an MPEG format with audio and video and associated metadata bundled as a single file. Cues can be obtained locally (at the local uplink) or may be transmitted from the NOC 632 to the spot server 626.

Still referring to FIG. 6, an exemplary operational flow is as follows:

1. At the uplink, receive the national feeds of the designated channels (CNN, ESPN, USA etc.) 634 into which advertisements will be inserted. Detect and extract cues 628 that are used by CATV from these feeds.

2. Use the cues 628 to play spots from a server 626, creating (part-time) channels (X₁, X₂, . . . , Xₙ). Creating these channels allows insertion into any n of the designated feeds simultaneously.

3. All spot start-of-insertion requests are inserted into channels (X₁, X₂, . . . , Xₙ) together with end-of-insertion requests and other splicing data.

4. Channels (X₁, X₂, . . . , Xₙ) are multiplexed 614 into the same transponder together with an emergency (EAS) signal feed 622, although the same transponder need not be used.

5. The consumer receives any of the DBS 624 or local channels 618 available. The local channels 618 may be multiplexed by multiplexer 616.

6. The set top box 600 has a dual tuner 602 that is tuned to whatever channel the viewer has chosen and in addition is always tuned to the transponder that includes channels (X₁, X₂, . . . , Xₙ), the accompanying metadata Y, and the EAS signal.

7. If the set top box is tuned to one of the designated national channels (such as CNN) 624 then the CNN bit stream is demultiplexed at demultiplexer 604 and fed into the buffer 606.

8. At the same time one of the channels (X₁, X₂, . . . , Xₙ) is also being demultiplexed because the receiver has a dual demultiplexer 604.

9. Using the metadata in Y, the processor 608 will select the appropriate spot channel (X₁, X₂, . . . , Xₙ) to demultiplex and will feed that signal into the buffer 606. For example, assume that the spot is in channel Xj.

10. This channel contains the replacement spot for CNN.

11. The output of the buffer 606 will switch to the spot at the point in the bit stream defined in the start-of-insertion request and switch back to CNN at the point in the bit stream defined by the end-of-insertion request.

12. A second receiver could at the same time be inserting a spot from channel Xₖ into ESPN and a third receiver could be inserting from channel X₁ into USA.

13. The number of simultaneous inserts may be defined by the number of spot channels n.

14. The spot channels need not be full time channels because there may be times when fewer than n of the designated channels are running commercials.

15. Multiple spots can be played back-to back to fill the duration of a program avail.

16. Each Uplink can insert different spots and can have its own X and Y channels so that different spots can be inserted in each local market, and this can be done for at least n program channels.

17. If bits are detected by the receiver in the EAS channel 622 a switch is made to EAS regardless of which channel the viewer was watching.

18. At the end of EAS the viewer is returned to the original channel.

Cable networks broadcast TV channels with commercials that can be pre-empted in favor of local advertisements by a local cable company or a network affiliate. These channels are often re-broadcast by DBS systems. Some embodiments of the invention can provide systems and/or methods to replace these commercials in the DBS environment and/or to insert new commercials or material in channels broadcast by DBS.

In some embodiments, an end-to-end system can concentrate knowledge of the available commercial slots (avails) in all channels and in all 210 Designated Market Areas (DMAs) in one place. In addition, the material to be inserted can be channeled through a central ingest center. Some embodiments can make possible reporting on the statistics of commercials aired. Reports of commercial airings may be collected in a central location and may be used for invoicing or providing make-goods on a national or local basis. Users of the system can therefore buy commercial replacements opportunities, provide a single copy of the material to a central source, and be invoiced for insertions in all markets from a single point of contact.

In some embodiments, the commercials can be tailored to localities and/or viewer preferences. An efficient technique for adapting a generic commercial to specific requirements may be provided. Streams of data, audio or video can be transmitted to set top boxes and appended or added to the generic commercial. The replacement material is transmitted to a satellite at approximately the same time that the commercial to be replaced would be airing. Thus, for example, an uplink may transmit a single video stream with multiple audio streams, allowing each market in its service area to receive the same video accompanied by audio specific to each market individually. Similarly, data streams may be used to create specific advertisements from a common generic video and audio stream.

Most content can be received in a format suitable for broadcast over the network. However, content ingest system 508 can have a media receiving function and a staging area for physical media. The physical media processing facilities can include CD ROM/DVD drives and various types of tape drive. Any content received can be converted into the house format 512 for distribution.

Once processed, content can be tagged with a unique identification number and stored for later retrieval by a spot server 514. The traffic system 522 can use this identification tag to track content throughout the network.

Embodiments of the invention can be applied entirely within the DBS network and/or in a framework in which another party provides local, regional or national channels for the DBS network (or networks) on a common platform. Certain channels in the DBS network can be designated for commercial replacement. Each channel provider can provide regular and ongoing descriptions of program schedules and associated avails. The DBS provider may also provide this information. Avails may be indicated by schedule, by minimum cumulative time per program or time period, and/or by other conventional techniques.

Referring to FIG. 5, a Program Avail Manager (PAM) 524 can track all such data for each designated channel. The PAM 524 can aggregate all avail information provided by the content providers 502, channel providers 504 and/or DBS providers 506, define an avail identification tag (or tag method) for use by uplinks 542 and set top boxes 544, distribute avail schedules to the uplinks 542 for sales and scheduling and collect as-aired data and statistics.

In some embodiments, cue and splicing methods developed for cable TV may be used, such as:

| | |
|---|---|
| SCTE 35 2001 | Digital program insertion cue messages for cable TV; |
| | and/or |
| SCTE 30 2001 | Digital program insertion splicing application program |
| | interface. |

Program schedules and avails can be defined in advance of programming events to allow operators to sell commercials into the available time slots. While some channels may have fairly static avail patterns, others may be more dynamic (e.g., live sporting events). For digital splicing of commercials, avails may be identified by the channel provider 504 in the MPEG domain by splice_event_id, unique program_id, and avail according to SCTE 35, where available. Such information however, may not be available in advance from the channel provider 504 and may be applied only upon transmission. The avail manager 524 can accommodate avail definitions from the channel providers 504, whether by MPEG descriptors, other cue processing, or by program/time descriptions. PAM 524 can allow changes and additions to be accepted as air time approaches.

The program avail manager 524 may interface with a cue processing system 528 that can process cues from a channel provider 504 and/or a DBS provider 506. The program avail manager 524 can have a cue message-parsing component that accepts each channel's cue messages and correlates them with the advance schedules. PAM 524 can note matches and exceptions and provide the raw expected and actual data for use by the operators. The PAM 524 may provide input to a cue generator 526.

Users with an account are allowed to purchase airtime using a centralized airtime sales system 518. All user account and scheduling information can be kept within a database on a traffic system 522. Airtime sales system 518 can query the traffic system 522 in order to authenticate users before granting access. All information relating to a particular contract can be retrieved from the traffic system 522 and presented to the user when an advertiser user logs into the front-end. Using this contract, the user is able to specify the broadcast parameters to transmit an advertisement.

Once connected, the user can receive a schedule of all avails for a specified time period and market(s). Still referring to FIG. 5, the traffic system 522 maintains a customer database, handles the creation of contracts, the scheduling of content for transmission from all uplinks and the tracking of content within the network. The traffic system 522 can perform one or more of the following functions:

determine the cost of a advertisement

map commercials to channels

track content within the uplinks

manage playout from the uplinks

maintain the scheduling and customer information databases.

The scheduling and content information received from the airtime sales server 518 is used to determine the total cost of the broadcast. The traffic system 522 can maintain rate cards that are used to dynamically update the cost of a transaction. The total cost for each transmission is forwarded to a billing system at defined intervals.

The traffic system 522 can associate advertisements with channels in which they are to be played and can receive notification messages from the uplinks when content has played out successfully. The traffic system 522 can manage the transmission of content from a Network Operations Center (NOC) to each uplink such that the content is available for scheduled playout. The traffic system 522 can notify the spot server 514 of content pending distribution to the local uplinks in time for the local uplinks to deliver real-time to STBs. The spot server 514 retrieves this content from storage and retrieves the associated metadata from the PAM system 524 before transmission begins. The spot server 514 can broadcast the content and associated metadata at the earliest opportunity, via multiplexer 516.

The traffic system 522 can be responsible for the creation of uplink-specific day-of air playlists for all transmissions within the next 24-hour period. Any update to a DMA schedule that affects the current play list period can force a play list update.

Still referring to FIG. 5, material may be distributed over WAN and/or national satellite feed 542 to Regional/local uplinks 546. The national feed can support the targeting of single uplinks, or the creation of target groups containing various uplinks or other target groups. The system can retransmit all content that has not been successfully received at the uplinks.

In the drawings and specification, there have been disclosed embodiments of the invention and, although specific terms are employed, they are used in a generic and descriptive sense only and not for purposes of limitation, the scope of the invention being set forth in the following claims.

What is claimed is:

1. A television program receiving method comprising:
simultaneously receiving a television program stream that includes television programs and at least one original commercial, and a commercial replacement stream that includes at least one replacement commercial, such that a respective replacement commercial is approximately synchronized in time with a respective original commercial;
buffering the television program stream and/or the commercial replacement stream to substantially synchronize a respective replacement commercial with a respective original commercial; and
selectively switching between the television program stream and the commercial replacement stream that are substantially synchronized, to provide a television program output that includes the television programs and the at least one replacement commercial instead of the at least one original commercial.

2. A method according to claim 1:
wherein the television program stream and/or the commercial replacement stream include switch commands that identify parameters for selectively switching between the television program stream and the commercial replacement stream; and
wherein selectively switching is performed responsive to the switch commands.

3. A method according to claim 1 further comprising:
receiving a switch command stream that includes switch commands that identify parameters for selectively switching between the television program stream and the commercial replacement stream; and
wherein selectively switching is performed responsive to the switch commands in the switch command stream.

4. A method according to claim 2 further comprising:
receiving a switch command stream that also includes switch commands that identify parameters for selectively switching between the television program stream and the commercial replacement stream; and
wherein selectively switching is performed responsive to the switch commands in the television program stream, in the commercial replacement stream and/or in the switch command stream.

5. A method according to claim 1 wherein selectively switching comprises splicing the television program stream and the commercial replacement stream that are substantially synchronized to provide the television program output that includes the television programs and the at least one replacement commercial instead of the at least one original commercial.

6. A method according to claim 1 further comprising:
providing the television program output that includes the television programs and the at least one replacement commercial instead of the at least one original commercial to a television receiver.

7. A method according to claim 1 wherein simultaneously receiving, buffering and selectively switching are performed in a set top box.

8. A method according to claim 1 wherein the television program stream and the commercial replacement stream comprise first and second direct broadcast satellite streams.

9. A method according to claim 1 wherein the television program stream comprises a direct broadcast satellite television regional program stream and the commercial replacement stream comprises a direct broadcast satellite local commercial replacement stream.

10. A television program transmitting method comprising:
simultaneously transmitting a direct broadcast satellite television regional program stream that includes regional television programs and at least one original commercial, and a direct broadcast satellite local commercial replacement stream that includes at least one local replacement commercial, such that a respective replacement commercial is approximately synchronized in time with a respective original commercial.

11. A method according to claim 10:
wherein simultaneously transmitting comprises simultaneously transmitting a direct broadcast satellite television regional program stream that includes regional television programs and at least one original commercial, and a direct broadcast satellite local commercial replacement stream that includes at least one local replacement commercial, such that a respective replacement commercial is substantially synchronized in time with a respective original commercial.

12. A method according to claim 10:
wherein the direct broadcast satellite television regional program stream and/or the direct broadcast satellite local commercial replacement stream include switch commands that identify parameters for selectively switching between the television program stream and the commercial replacement stream.

13. A method according to claim 10 further comprising:
transmitting a switch command stream that includes switch commands that identify parameters for selectively switching between the television program stream and the commercial replacement stream.

14. A method according to claim 12 further comprising:
transmitting a switch command stream that also includes switch commands that identify parameters for selectively switching between the television program stream and the commercial replacement stream.

15. A method according to claim 10 wherein simultaneously transmitting is performed by a direct broadcast satellite television broadcasting system.

16. A method according to claim 10 wherein the direct broadcast satellite television regional program stream is a first direct broadcast satellite television regional program stream and wherein simultaneously transmitting comprises simultaneously transmitting the first direct broadcast satellite television regional program stream and a second direct broadcast satellite television regional program stream that includes television programs and original commercials, and wherein the direct broadcast satellite local commercial replacement stream includes at least one local replacement commercial for the first direct broadcast satellite television regional program stream and at least one replacement commercial for the second direct broadcast satellite television regional program stream, such that a respective local replacement commercial is approximately synchronized in time with a respective original commercial.

17. A method according to claim 11 wherein the direct broadcast satellite television regional program stream and the direct broadcast satellite local commercial replacement stream are simultaneously transmitted from two different locations.

18. A method according to claim 10 wherein the direct broadcast satellite local commercial replacement stream comprises a plurality of direct broadcast satellite local commercial replacement streams, each of which includes at least one local replacement commercial, such that a respective replacement commercial is approximately synchronized in time with a respective original commercial.

19. A method according to claim 18, further comprising:
transmitting a switch command stream that includes switch commands that identify parameters for selectively switching between the direct broadcast satellite television regional program stream and the plurality of direct broadcast satellite local commercial replacement streams.

20. A set top box comprising:
a receiver that is configured to simultaneously receive a television program stream that includes television programs and at least one original commercial, and a commercial replacement stream that includes at least one replacement commercial, such that a respective replacement commercial is approximately synchronized in time with a respective original commercial;
a synchronization buffer that is configured to buffer the television program stream and/or the commercial replacement stream to substantially synchronize a respective replacement commercial with a respective original commercial; and
a switch that is configured to selectively switch between the television program stream and the commercial replacement stream that are substantially synchronized to provide a television program output that includes the television programs and the at least one replacement commercial instead of the at least one original commercial.

21. A set top box according to claim 20:
wherein the television program stream and/or the commercial replacement stream include switch commands that identify parameters for selectively switching between the television program stream and the commercial replacement stream; and
wherein the switch is controlled by the switch commands.

22. A set top box according to claim 20:
wherein the receiver is further configured to receive a switch command stream that includes switch commands that identify parameters for selectively switching between the television program stream and the commercial replacement stream; and
wherein the switch is controlled by the switch commands in the switch command stream.

23. A set top box according to claim 21:
wherein the receiver is further configured to receive a switch command stream that includes switch commands that identify parameters for selectively switching between the television program stream and the commercial replacement stream; and
wherein the switch is controlled by the switch commands in the television program stream, in the commercial replacement stream and/or in the switch command stream.

24. A set top box according to claim 20 wherein the switch comprises a splicer.

25. A set top box according to claim 22 wherein the receiver is further configured to demultiplex the switch command stream and the commercial replacement stream.

26. A set top box according to claim 23 wherein the receiver is further configured to demultiplex the switch command stream and the commercial replacement stream.

27. A set top box according to claim 20 further comprising:
an output system that is configured to provide the television program output that includes the television programs and the at least one replacement commercial instead of the at least one original commercial to a television receiver.

28. A set top box according to claim 20 wherein the set sop box is free of a mass storage device that is configured to store the television program stream and/or the commercial replacement stream.

29. A set top box according to claim 20 wherein the television program stream and the commercial replacement stream comprise first and second direct broadcast satellite streams.

30. A set top box according to claim 20 wherein the television program stream comprises a direct broadcast satellite television regional program stream and the commercial replacement stream comprises a direct broadcast satellite local commercial replacement stream.

31. A television program receiving system comprising:
means for simultaneously receiving a television program stream that includes television programs and at least one original commercial, and a commercial replacement stream that includes at least one replacement commercial, such that a respective replacement commercial is approximately synchronized in time with a respective original commercial;
means for buffering the television program stream and/or the commercial replacement stream to substantially synchronize a respective replacement commercial with a respective original commercial; and
means for selectively switching between the television program stream and the commercial replacement stream that are substantially synchronized to provide a television program output that includes the television programs and the at least one replacement commercial instead of the at least one original commercial.
